(19) United States
(12) Patent Application Publication
(10) Pub. No.: US 2008/0026784 A1
(43) Pub. Date: Jan. 31, 2008

(54) METHOD AND SYSTEM FOR RAPID INITIATION SEQUENCE FOR MOBILE UNIT

(75) Inventors: Peter M. Pavlov, Plantation, FL (US); Dilip K. Doshi, Coral Springs, FL (US); Jason D. McIntosh, Sugar Hill, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: MOTOROLA, INC., Schaumburg, IL (US)

(21) Appl. No.: 11/461,157

(22) Filed: Jul. 31, 2006

(51) Int. Cl. H04M 1/00

(52) U.S. Cl. 455/550.1

(57) ABSTRACT

The invention concerns a method (200) and a mobile unit (100) for a rapid initiation sequence. The method can include the steps of receiving (210) a rapid initiation sequence command and in response, bypassing (212) a normal initiation sequence in favor of a rapid initiation sequence such that only those components of the mobile unit that are necessary to permit a user to initiate a call from the mobile unit are initially activated. As an example, the initiated call can be an emergency call to an emergency operations center (132). The method can also include the step of completing (220) the normal initiation sequence once the rapid initiation sequence is completed.

### BACKGROUND OF THE INVENTION

1. Field of the Invention

The present invention concerns the control of initiation sequences and more particularly, the control of such sequences to speed their occurrence in mobile communication units.

2. Description of the Related Art

The market for mobile communication units, or simply, mobile units, has increased tremendously in recent years. In an effort to distinguish their products, mobile unit manufacturers and wireless carriers have packed such devices with various features, such as digital music players, video players and global positioning system (GPS) circuitry, as well as advanced mobile operating systems. Because of these additional features, the amount of time that it takes for a mobile unit to proceed through its initiation or boot-up sequence has correspondingly risen.

As such, it may take a significant amount of time before a user is able to make (or receive) a phone call. This delay may annoy a user who wishes to make a phone call as quickly as possible when turning on his or her mobile unit. Even worse, this delay may be life-threatening if the user wishes to initiate an emergency call.

### SUMMARY OF THE INVENTION

The present invention concerns a method for a rapid initiation sequence in a mobile unit. The method can include the steps of receiving a rapid initiation sequence command and in response bypassing a normal initiation sequence in favor of a rapid initiation sequence such that only those components of the mobile unit that are necessary to permit a user to initiate a call from the mobile unit are initially activated. As an example, the call can be an emergency call to an emergency operations center, and the rapid initiation sequence command can be received from a user interface component. The user interface component may be one or more keys of a keypad of the mobile unit or a touch-screen display of the mobile unit.

Bypassing the normal initiation sequence may include initially avoiding the activation of non-critical applications of the mobile unit or activating only that portion of the operating system of the mobile unit that is necessary to initiate the call from the mobile unit. Additionally, the normal initiation sequence may be completed once the rapid initiation sequence is finished. For example, the process of completing the normal initiation sequence can occur during the initiated call or after the initiated call is completed. The method may also include the step of registering with a communication network in a lowest-supported mobile communication mode.

The present invention also concerns a mobile unit capable of activating a rapid initiation sequence or a normal initiation sequence. The mobile unit can include a user interface component and a processor communicatively coupled to the user interface component. In one arrangement, the processor can be programmed to receive a rapid initiation sequence command from the user interface component and in response, bypass a normal initiation sequence in favor of a rapid initiation sequence such that only those components of the mobile unit that are necessary to permit a user to initiate a call from the mobile unit are initially activated. The mobile unit may also contain suitable software and circuitry to perform any of the steps listed above.

The present invention also concerns a machine readable storage, having stored thereon a computer program having a plurality of code sections executable by a mobile unit. The program can cause the mobile unit to perform the steps of receiving a rapid initiation sequence command and in response, bypassing a normal initiation sequence in favor of a rapid initiation sequence such that only those components of the mobile unit that are necessary to permit a user to initiate a call from the mobile unit are initially activated. The program can also cause the mobile unit to perform any of the steps listed above.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates an example of a mobile unit that can perform a rapid initiation sequence in accordance with an embodiment of the inventive arrangements; and

FIG. 2 illustrates a method for rapid initiation sequence in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled” as used herein, are defined as connected, although not necessarily directly, and not necessarily mechanically. The term “processor” can include any component or group of components, including any relevant hardware and/or software, that can carry out the functions described in relation to the inventive arrangements herein.

The term “mobile unit” can be defined as any portable electronic device capable of receiving and/or transmitting wireless communication signals. The term “call” can be defined as any type of communication in which voice and/or data is at least transmitted from a mobile unit. In addition, the term “application” can be defined as any computer program designed to perform a specific function, and a “sequence” can be defined as a predetermined set of steps or processes to be executed.

The invention concerns a method and system for a rapid initiation sequence in a mobile unit. In one arrangement, the method can include the steps of receiving a rapid initiation sequence command and in response, bypassing a normal initiation sequence in favor of a rapid initiation sequence such that only those components of the mobile unit that are necessary to permit a user to initiate a call from the mobile unit are initially activated. As an example, the initiated call can be an emergency call to an emergency operations center. The method can also include the step of completing the normal initiation sequence once the rapid initiation sequence is completed. Because it skips (temporarily) the activation of certain programs and components, the rapid initiation sequence can enable a user of the mobile unit to initiate a call on the mobile unit much faster than normal. This feature is quite useful, particularly if the user wishes to make, for example, an emergency phone call.

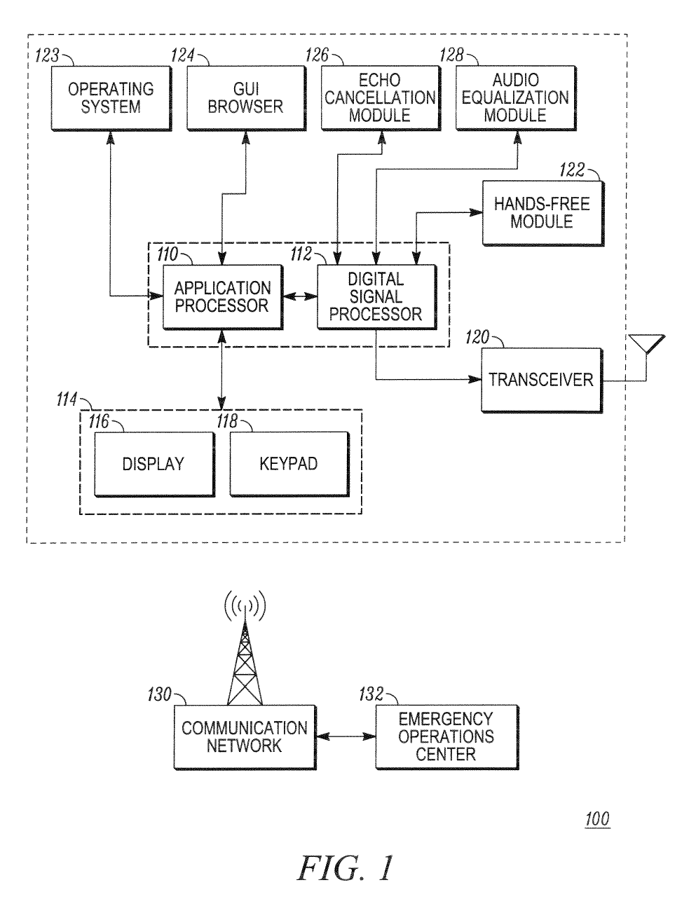

Referring to FIG. 1, a mobile unit 100 capable of performing a rapid initiation sequence is shown. In one arrangement, the mobile unit 100 can include an application processor 110 and a digital signal processor (DSP) 112, which may be communicatively coupled with one another. As is known in the art, the application processor 110 may handle processes associated with various user interface-related applications, and the DSP 112 can perform computationally-intensive processes, such as those relating to the processing of incoming or outgoing wireless signals. For purposes of the invention, however, the application processor 110 and the DSP 112 may be simply referred to as a processor. Nonetheless, it is understood that the invention is in no way limited to this particular arrangement, as the mobile unit 100 can include any suitable number of processors and any suitable type of configuration for executing the inventive steps described herein.

The mobile unit 110 may also include a user interface 114, which can be communicatively coupled to the application processor 110 and can include a display 116 and a keypad 118. As an example, the display 116 can be a touch-screen display that allows user to make selections directly from the screen of the display 116. In addition, the keypad 118 can include any suitable number of keys (not shown), several of which may be programmable keys (i.e., soft keys). Those of skill in the art will appreciate that the user interface 114 may include other suitable components that are capable of relaying to the application processor 110 any number of commands initiated by the user or some other entity.

The mobile unit 100 may also contain a transceiver 120 for exchanging wireless signals with wide area networks, such as a communication network 130 and a hands-free module 122, both of which may be communicatively coupled with the DSP 112. The hands-free module 122 can include any suitable software and circuitry for enabling short range communications with an accessory, whether wired or wireless. For example, the hands-free module 122 may be a Bluetooth transceiver.

The mobile unit 100 may also include an operating system 123. In one embodiment, the operating system 123 may be a bifurcated system in which the system 123 contains a full version and a truncated version. The full version may include all applications that are normally loaded when the mobile unit 100 is booted-up or first turned on. In contrast, the truncated version may only include those portions of the operating system that are necessary for initiating a call from the mobile unit 100, such as interprocessor communication software, dialer software, telephone application program interface (TAPI) software, etc. The truncated version is not limited to these particular examples, as other systems may include different programs or applications that are within the scope of this invention.

In one arrangement, the mobile unit 100 may contain one or more non-critical applications. A non-critical application can refer to any component, including both hardware and software, in which the activation of such component is not essential to a mobile unit being able to initiate a call from the mobile unit. For example, the mobile unit 100 may contain a GUI browser 124, an echo cancellation module 126 or an audio equalization module 128. These components, as those of skill in the art will appreciate, may improve the use of the mobile unit 100, but they are not required to be activated for a user to initiate a call from the mobile unit 100. Those of skill in the art will appreciate that the mobile unit 100 is not limited to these particular examples, as the unit 100 may contain other suitable non-critical applications.

The mobile unit 100 may communicate with one or more communication networks 130, and the network 130 can be any suitable type of network that can transmit wireless signals to and receive wireless signals from the mobile unit 100. It must also be noted that the mobile unit 100 can be configured to communicate to other mobile units without the assistance of the network 130. In one arrangement, the network 130 may relay communications signals between the mobile unit 100 and an emergency operations center 132. As an example, the emergency operations center 132 can be a government unit that handles emergency police and fire calls, although the center 132 may process other types of calls, too.

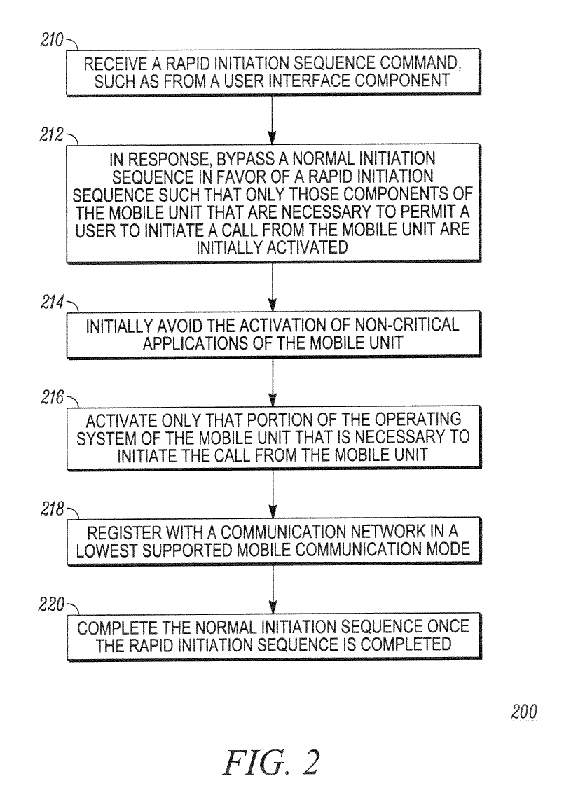

Referring to FIG. 2, a method 200 for a rapid initiation sequence for a mobile unit is shown. When describing the method 200, reference will be primarily made to FIG. 1, although it is understood that the method 200 can be practiced in any other suitable system or device. Moreover, the steps of the method 200 are not limited to the particular order in which they are presented in FIG. 2. The inventive method can also have a greater number of steps or a fewer number of steps than those shown in FIG. 2.

At step 210, a rapid initiation sequence command can be received, such as from a user interface component. At step 212, in response, a normal initiation sequence can be bypassed in favor of a rapid initiation sequence such that only those components of the mobile unit that are necessary to permit a user to initiate a call from the mobile unit are initially activated. In particular, the activation of non-critical applications of the mobile unit can be initially avoided, as shown at step 214. Moreover, at step 216, only that portion of the operating system of the mobile unit that is necessary to initiate the call from the mobile unit should be activated.

For example, referring to FIG. 1, a rapid initiation sequence command can be received at the application processor 110 from the user interface 114. Specifically, a user can press an on/off button and can then press one or more keys of the keypad 118. Alternatively, the user can select a menu item from the touch-screen display 116 or by using the keys of the keypad 118. The menu may be part of the display material that normally appears on the display 116 during start-up of the mobile unit 100. The user initiating this command may need to initiate a call quickly, such as in the event of an emergency. If desired, the mobile unit 100 can be configured to recognize a rapid initiation sequence command for an emergency call or a conventional social or business call. For example, the user may press a different set of keys or menu selections for an emergency call as opposed to those for a conventional call to enable the mobile unit 100 to determine the user's intention to place an emergency call.

In response, the application processor 110 can cause a normal initiation sequence to be bypassed in favor of a rapid initiation sequence. For purposes of the invention, a rapid initiation sequence can be a sequence where only those components that are necessary to permit a user to initiate a call from the mobile unit are initially activated when the mobile unit 100 is booted up. In contrast, a normal initiation sequence can be a sequence that is typically followed during the boot-up of the mobile unit 100 in the absence of any special circumstances.

As part of the rapid initiation sequence, the activation of non-critical applications may be initially avoided. For example, the activation of the GUI browser 124, the echo cancellation module 126 or the audio equalization module 128 could be delayed or even entirely prevented. Moreover, the application processor 110 could signal the DSP 112 to delay the activation of the hands-free module 122. While all these components enhance the user experience with the mobile unit 110, none of them are necessarily essential to initiating a call from the unit 100.

Those components that are necessary to enable the user to initiate a call, however, can be activated at start-up. For example, the DSP 112 can activate the transceiver 120 and other components that are essential for processing voice and/or data signals, such as a vocoder. Other elements that may be activated during the rapid initiation sequence are the display 116 and/or the keypad 118. Additionally, the application processor 110 can load or activate the truncated version of the operating system 123. In one particular example, this process can postpone the loading of certain applications or processes of the operating system 123, such as a calendar application, ring tones or other multimedia files. If desired, if the mobile unit 100 contains a GPS unit, that unit can be activated as part of the rapid initiation sequence. The activation of the GPS unit may be useful if the call to be initiated is an emergency call.

It is important to note that the invention is not limited to any of the examples described above. Those of skill in the art will appreciate that any suitable components that are necessary for initiating a call from a mobile unit may be activated in the rapid initiation sequence. Those of skill in the art will also appreciate that any number of the remaining components that are not necessary for the call initiation may remain at least temporarily deactivated through the rapid initiation sequence.

Referring back to the method 200 of FIG. 2, at step 218, a communication network can be registered with in a lowest-possible generation mode. In addition, at step 220, the normal initiation sequence can be completed once the rapid initiation sequence is finished. For example, referring once again to FIG. 1, during the initiation of the call in the rapid initiation sequence, the mobile unit 100 can register with the communication network 130 in the lowest possible generation mode. In particular, if both the mobile unit 100 and the network 130 support second generation (2G) communications, then the mobile unit 100 can register with the network 130 in that mode, even if both support, for example, third generation (3G) communications. Of course, if the mobile unit 100 or the network 130 does not support 2G communications, then the registration can be for the next lowest mode, such as a 2.5G mode and so on. This process can lead to a faster connection time between the mobile unit 100 and the network 130. Moreover, the lower communication mode requires less processing power, which can lead to less power being drawn from the battery (not shown) of the mobile unit 100.

Once the rapid initiation sequence of the mobile unit 100 is finished, as an option, the normal initiation sequence can be completed. In particular, those processes and components whose activations were skipped in the rapid initiation sequence may be carried out. This step can bring the mobile unit 100 into a normal operating mode without increasing the amount of time needed to initiate a call. This process can occur either during the initiated call or after the initiated call is completed.

The embodiments described above enable a user to quickly establish a call from the mobile unit 100. This feature can be useful if the user needs to make an emergency phone call, such as a 911 call to an emergency dispatcher at the emergency operations center 132. It is important to note, however, that the rapid initiation sequence is not limited to emergency calls; rather, this sequence can be utilized if a user merely wishes to establish communications faster than would be done in the normal initiation sequence, including for social or business calls.

It is also important to note that the mobile unit 100 may maintain its operations in accordance with the rapid initiation sequence. For example, once the rapid initiation sequence is complete, the mobile unit 100 may avoid the completion of the normal initiation sequence. As such, those components associated with normal initiation sequence may remain deactivated for an extended period of time. This process can reduce the amount of current drawn from the battery. As an option, the mobile unit 100 can be programmed to permit a user to maintain the mobile unit 100 in this reduced operation state at his/her discretion.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for a rapid initiation sequence in a mobile unit, comprising:
receiving a rapid initiation sequence command; and
in response, bypassing a normal initiation sequence in favor of a rapid initiation sequence such that only those components of the mobile unit that are necessary to permit a user to initiate a call from the mobile unit are initially activated.

2. The method according to claim 1, wherein the call is an emergency call to an emergency operations center.

3. The method according to claim 1, further comprising receiving the rapid initiation sequence command from a user interface component.

4. The method according to claim 3, wherein the user interface component is one or more keys of a keypad of the mobile unit or a touch-screen display of the mobile unit.

5. The method according to claim 1, wherein bypassing the normal initiation sequence comprises initially avoiding the activation of non-critical applications of the mobile unit.

6. The method according to claim 1, wherein bypassing the normal initiation sequence comprises activating only that portion of the operating system of the mobile unit that is necessary to initiate the call from the mobile unit.

7. The method according to claim 1, further comprising completing the normal initiation sequence once the rapid initiation sequence is completed.

8. The method according to claim 7, wherein the process of completing the normal initiation sequence occurs during the initiated call or after the initiated call is completed.

9. The method according to claim 1, further comprising registering with a communication network in a lowest-supported mobile communication mode.

10. A mobile unit capable of activating a rapid initiation sequence or a normal initiation sequence, comprising:
a user interface component; and
a processor, wherein the processor is communicatively coupled to the user interface component and is programmed to:
receive a rapid initiation sequence command from the user interface component; and
in response, bypass a normal initiation sequence in favor of a rapid initiation sequence such that only those components of the mobile unit that are necessary to permit a user to initiate a call from the mobile unit are initially activated.

11. The mobile unit according to claim 10, wherein the call is an emergency call to an emergency operations center.

12. The mobile unit according to claim 10, wherein the user interface component is one or more keys of a keypad of the mobile unit or a touch-screen display of the mobile unit.

13. The mobile unit according to claim 10, wherein the processor bypasses the normal initiation sequence by initially avoiding the activation of non-critical applications of the mobile unit.

14. The mobile unit according to claim 10, wherein the processor bypasses the normal initiation sequence by activating only that portion of the operating system of the mobile unit that is necessary to initiate the call from the mobile unit.

15. The mobile unit according to claim 10, wherein the processor is further programmed to complete the normal initiation sequence once the rapid initiation sequence is completed.

16. The mobile unit according to claim 15, wherein the processor is further programmed to complete the normal initiation sequence during the initiated call or after the initiated call is completed.

17. The mobile unit according to claim 15, wherein the processor is further programmed to register the mobile unit with a communication network in a lowest-supported mobile communication mode.

18. A machine readable storage, having stored thereon a computer program having a plurality of code sections executable by a mobile unit for causing the mobile unit to perform the steps of:
receiving a rapid initiation sequence command; and
in response, bypassing a normal initiation sequence in favor of a rapid initiation sequence such that only those components of the mobile unit that are necessary to permit a user to initiate a call from the mobile unit are initially activated.

19. The machine readable storage according to claim 18, wherein the call is an emergency call to an emergency operations center.

20. The machine readable storage according to claim 18, wherein the computer program further causes the mobile unit to complete the normal initiation sequence once the rapid initiation sequence is completed.
